(19) United States
(12) Patent Application Publication
(10) Pub. No.: US 2012/0170787 A1
(43) Pub. Date: Jul. 5, 2012

(54) DECORATIVE DESIGN MOLDED ONTO AN EARPHONE/HEADPHONE CORD

(76) Inventor: Trevor Staley, Agoura Hills, CA (US)

(21) Appl. No.: 13/342,572

(22) Filed: Jan. 3, 2012

Related U.S. Application Data
(60) Provisional application No. 61/460,425, filed on Jan. 3, 2011.

(51) Int. Cl. H04R 1/10

(52) U.S. Cl. 381/370

(57) ABSTRACT

This is directed to systems, processes, machines, and other means that relate to decorative earphone and headphone cords. The invention can allow users to express themselves with a new article of manufacture.

### CROSS REFERENCE TO RELATED APPLICATIONS

This application claims priority to provisional application No. 60/###,###

### p STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION BY REFERENCE OF MATERIAL SUBMITTED ON A COMPACT DISC

Not Applicable

### FIELD OF THE INVENTION

The invention relates to incorporating ornamental features onto the earphone cords that connect earphones, headphones, ear buds, and any other small loudspeakers that are used close or in the user's ear, with a listening device, such as mp3 players, cd players, radios, media players etc.

### BACKGROUND OF THE INVENTION

Contemporary earphones and headphones are connected to a listening device with an unadorned earphone cord. Previous devices teach that an ornament can be attached to the by using an aftermarket clip on device. However, these devices are temporary and leave open the issue of creating permanent ornaments onto earphone cords.

The present invention solves the problem of earphone users having unadorned cords by teaching an article of manufacture that incorporates a permanent ornamental earphone cord.

### BACKGROUND ART

The Zeig U.S. patent application No. 2008/0285785 A1 teaches an ornamental addition to a headphone cord that is attached by clipping the device to the cord. It does not teach an ornamental headphone cord with a permanently fixed ornament.

The Ko U.S. Pat. No. 7,715,888 B3 teaches an ornamental necklace used as a Bluetooth earphone piece. The ornament is held over the necklace with a single piece of material and is not permanently affixed to the cord.

### BRIEF SUMMARY OF THE INVENTION

Methods, systems, and other means are provided for an ornamental design molded onto an earphone or headphone cord. In accordance with some embodiments, the invention allows a user a pair of earphones/headphones to display the ornamental cord to others around the user. This may inform others of the users fashion and personality.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is an explanatory illustration of the invention in use.

FIG. 2 is a detailed section view of the invention taken along a line 2-2 shown in FIG. 1.

FIG. 3 is a perspective view of an alternate embodiment of the invention in use.

### DETAILED DESCRIPTION OF THE INVENTION

Stereo headphones have existed since 1958; however, the cords have largely been plain and unadorned. These unadorned cords do not provide the user with an effective means to express oneself. Recent developments in this field have not resulted in an effective resolution.

As explained above, essentially two solutions have evolved: 1) attaching an ornament to a cord by snapping a hallow ornament onto the cord and 2) attaching the ornament to the cord by sliding the ornament over the cord. Neither solution results in a permanent cord ornament and both fail to allow users to express themselves in the same manner as a permanent cord ornament.

Embodiments of the present invention overcome the obstacles associated with temporary ornaments, and now will be described more fully hereinafter with reference to the accompanying drawings that show some, but not all, embodiments of the claimed inventions. Indeed, the invention may be embodied in many different forms and should not be construed as limited to the embodiments set forth herein. Rather, these embodiments are provided so that this disclosure will satisfy applicable legal requirements. Like numbers refer to like elements throughout.

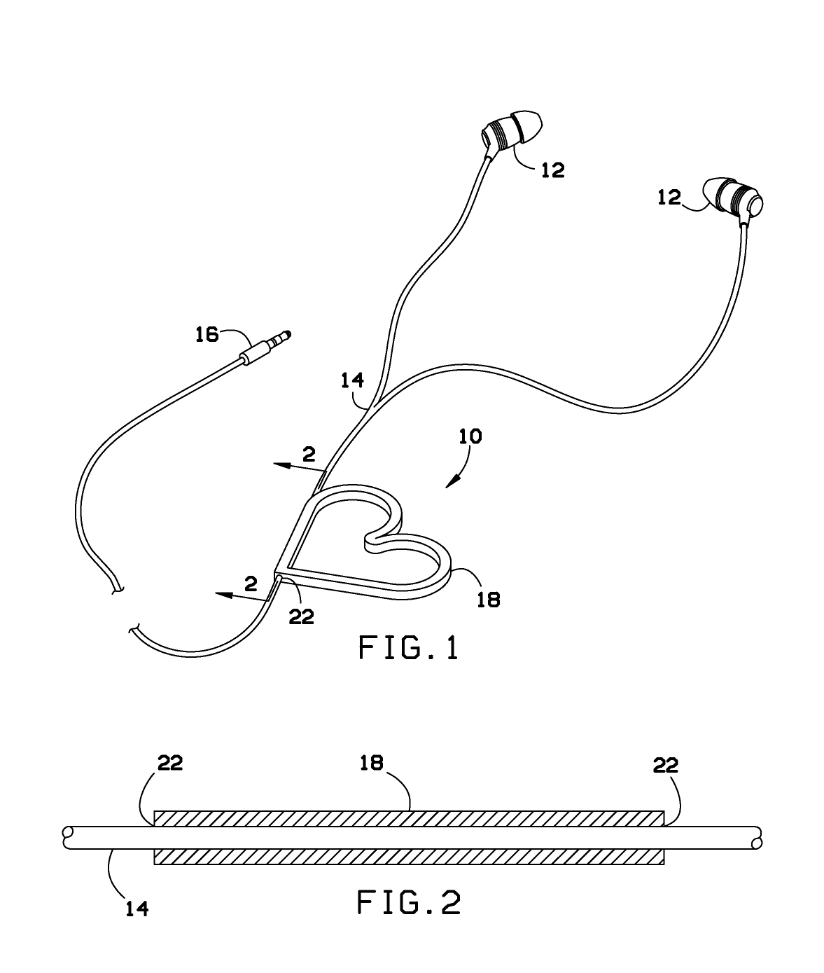

Turning to FIG. 1, overall invention 10 contains earphone speakers 12. Earphone speakers 12 are communicatively coupled to earphone cord 14. Earphone cord 14 contains molded decorative symbol 18. Molded decorative symbol 18 contains molded opening 22 for earphone cord 14. Earphone cord 14 is communicatively coupled with earphone speaker 16. Earphone cord 14 contains at least two wires, a first wire which can provide stereo sound to a first earphone speaker 16 and a second wire which provides sound to a second earphone speaker 16. Both wires are joined inside earphone cord 14. However, that need not be the case. Both wires could separately enter and exit molded decorative symbol 18 through a plurality of molded opening 22 before being joined together in a since earphone cord 14 before entering earphone speaker 16.

In one embodiment, the earphone cord is placed in a plastic mold. The plastic mold is then filled with molten plastic constrained in the plastic mold by molded opening 22 on each end of earphone cord 14. After the plastic hardens, molded decorative symbol is permanently fixed to earphone cord 14. Depending on the heat of the plastic it may be necessary to insure that earphone cord 14 is produced using double insulated speaker cable to prevent damage to the first wire and the second wire.

The rigidity of molded decorative symbol 18 can be adjusted to fit the user's preference. For example, it is easier to wrap earphone cord 14 around molded decorative symbol 18 to store molded decorative symbol 18 when it is not in use when the plastic is rigid and the cords are less likely to become tangled. However, other users may prefer a malleable molded decorative symbol 18 so that it can fit into a different shaped space, such as a pocket.

Turning to FIG. 2, a cross section of molded decorative symbol 18. This figure shows how earphone cord 14 is completely covered by molded decorative symbol 18 between two points marked by molded opening 22. The plurality of molded openings shown here by the two points represent an entry point and an exit point for the earphone cord.

In addition to molded plastic discussed above molded decorative symbol 18 could be made of rubber-like polymers, metal, wood, etc. Materials which may have elastic properties may also be used. For instance, if wood were used, the wood could be bored and then earphone cord 14 could be slid through molded decorative symbol 18 before earphone speaker 16 is attached on the end.

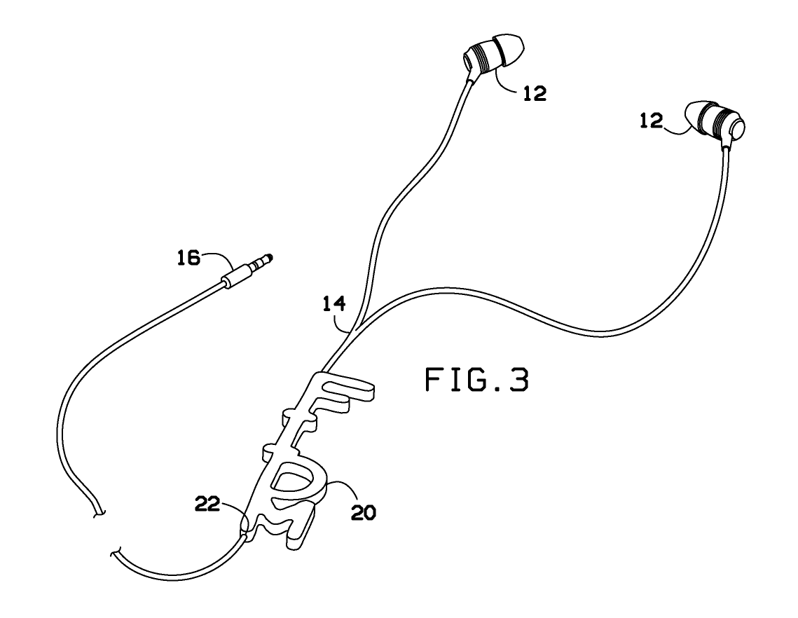

Turning to FIG. 3, an alternate embodiment of the invention where earphone cord 14 contains molded alphanumeric characters 20. Molded alphanumeric characters 20 contains molded opening 22 for earphone cord 14. Here, any combination from the set of alphanumeric characters can be used from the selection of A, B, C, D, E, F, G, H, I, J, K, L, M, N, 0, P, Q, R, S, T, U, V, W, X, Y, Z, a, b, c, d, e, f, g, h, i, j, k, l, m, n, o, p, q, r, s, t, u, v, w, x, y, z, 1, 2, 3, 4, 5, 6, 7, 8, 9, 0.

One version of an embodiment is comprised of a front side and a back side, both may be identical on either side. In addition to molded alphanumeric characters 20 the ornamental object may be shapes or hearts. One embodiment of the earphone cord 14 may be customizable by the user by manipulating the cord to a desired shape. This may allow the user to express himself or herself further.

This technology can be applied to headphone cords as well. In headphone cords, there is typically one earphone speaker, connected to a second earphone speaker which then has a single earphone cord leaving the second speaker. In this case, that single headphone cord could be placed in the plastic mold as discussed above.

That which is claimed:

1. An article of manufacture comprising,
An earphone cord communicatively coupled to a first earphone speaker and communicatively coupled to a second earphone speaker;
A molded decorative symbol permanently fixed to the earphone cord where the earphone cord further comprises a plurality of molded openings;
where the plurality of molded openings provide an entry point and an exit point for the earphone cord
the molded decorative symbol further comprises a front side and a back side

2. The article of manufacture in claim 1 where the front side and the back side are the same design.

3. The article of manufacture in claim 1 where the front side and the back side are different designs.

4. The article of manufacture in claim 1 where the molded decorative symbol is selected from a set of alphanumeric characters.

5. The article of manufacture in claim 1 where the earphone cord is double insulated.

6. The article of manufacture in claim 1 where the molded decorative symbol is rigid.

7. The article of manufacture in claim 1 where the molded decorative symbol is malleable.

8. An article of manufacture comprising,
A headphone cord commutatively coupled to a first earphone speaker and commutatively coupled to a second earphone speaker;
A molded decorative symbol permanently fixed to the headphone cord where
the headphone cord further comprises a plurality of molded openings;
where the plurality of molded openings provide an entry point and exit point for the headphone cord
the molded decorative symbol further comprises a front side and a back side

9. The article of manufacture in claim 8 where the front side and the back side are the same design.

10. The article of manufacture in claim 8 where the front side and the back side are different designs.
